(19) United States
(12) Patent Application Publication
(10) Pub. No.: US 2026/0325992 A1
(43) Pub. Date: Oct. 22, 2026

(54) Automated multiphase extraction and separation system for contaminated sites

(71) Applicant: Tongji University, Shanghai (CN)

(72) Inventors: Shijin FENG, Shanghai (CN); Zhenxing SUN, Shanghai (CN); He CHEN, Shanghai (CN); Qiteng ZHENG, Shanghai (CN); Hongxin CHEN, Shanghai (CN)

(73) Assignee: Tongji University, Shanghai (CN)

(21) Appl. No.: 19/533,158

(22) Filed: Feb. 7, 2026

(30) Foreign Application Priority Data
Apr. 17, 2025 (CN) 202510487088.2

(51) Int. Cl. B01D 17/12; B01D 17/02; B01D 17/04

(52) U.S. Cl. CPC B01D 17/12; B01D 17/0208; B01D 17/0211; B01D 17/0217; B01D 17/045

(57) ABSTRACT

The present invention provides an automated multiphase extraction and separation system for contaminated sites, comprising a solid-phase separation device, a gas-phase separation device, a NAPL phase separation device, a vacuum pumping device, a VOC treatment device and a control cabinet, which is configured for separating silt containing adsorbed organic matter, gas containing volatile organic compounds, water containing dissolved organic matter, light non-aqueous phase liquids (LNAPL) and dense non-aqueous phase liquids (DNAPL). The system of the present invention integrates multiphase extraction and multiphase separation into one unit

### CROSS-REFERENCE

This application claims the benefit of priority from China Patent Application No. CN 202510487088.2 filed on Apr. 17, 2025, the contents of which are hereby incorporated by reference in their entirety.

### TECHNICAL FIELD

The present invention relates to the technical field of soil remediation for contaminated sites, specifically to an automated multiphase extraction and separation system for contaminated sites.

### BACKGROUND ART

The rapid advancement of urbanization and the high-speed development of the chemical industry have generated a large amount of organic waste, leading to a year-on-year increase in the number of contaminated sites. Therefore, there is an urgent need for efficient contaminated site remediation technologies. Soil organic pollutants are mainly classified into volatile organic compounds (VOCs), dissolved organic matter (DOM), adsorbed organic matter, and non-aqueous phase liquids (NAPL). NAPL can be further classified by density into light non-aqueous phase liquids (LNAPL) and dense non-aqueous phase liquids (DNAPL). Currently, remediation technologies for contaminated sites mainly include multiphase extraction, chemical oxidation, solidification and stabilization, and biodegradation. Among these, multiphase extraction technology uses a vacuum method to extract contaminated groundwater, gases, and NAPL to the surface, thereby reducing the content of organic pollutants in soil and groundwater. Multiphase extraction technology has been widely used due to its ability to rapidly control and simultaneously remediate underground contamination. Currently, multiphase extraction equipment in China is still in its early stages of development. Existing equipment typically only extracts underground pollutants and transports them to hazardous waste treatment facilities, making on-site separation and treatment difficult. Furthermore, it is complex to operate existing multiphase extraction equipment, a high level of technical skill and expertise from operators is usually required, and it is not possible to achieve automated and stable operation. Therefore, developing stable and efficient multiphase extraction equipment to meet the national demand for contaminated site remediation is of great significance for environmental protection and public safety.

### SUMMARY OF THE INVENTION

To address the shortcomings of existing multiphase extraction equipment, the present invention provides an automated multiphase extraction and separation system for contaminated sites.

The technical solution of the present invention:
An automated multiphase extraction and separation system for contaminated sites, comprising: a solid-phase separation device a, a gas-phase separation device b, a non-aqueous phase liquids (NAPL) phase separation device c, a vacuum pumping device d, a volatile organic compound (VOC) treatment device e, and a control cabinet f, wherein:
the solid-phase separation device a is configured to separate silt in adsorbed organic matters from extracts; the extracts after silt separation are transported to the gas-phase separation device b;
the gas-phase separation device b is configured to separate gas in volatile organic compounds from the extracts, while water and non-aqueous phase liquids NAPL containing dissolved organic matter are pumped to the NAPL phase separation device c;
the NAPL phase separation device c is configured to separate water containing dissolved organic matter, light non-aqueous liquid (LNAPL), and heavy non-aqueous liquid (DNAPL);
the vacuum pumping device d provides negative pressure for multiphase extraction, extracting the gas containing volatile organic compounds from a tank of the gas phase separation device b, which is then purified by the VOC treatment device e before being discharged; and
the control cabinet f is connected to the solid phase separation device a, the gas phase separation device b, the NAPL phase separation device c, and the vacuum pumping device d, and is used to automate multiphase extraction and separation operations.

Due to the above technical solutions, the beneficial effects of the present invention are:
1. The automated multiphase extraction and separation system for contaminated sites of the present invention integrates multiphase extraction and multiphase separation, enabling simultaneous extraction and separation, thereby significantly improving the remediation efficiency and pollutant treatment efficiency of soil organic pollution.
2. For separation of extracts, solid-phase separation devices, gas-phase separation devices, and NAPL phase separation devices were developed to separate silt containing adsorbed organic matter, gas containing volatile organic matter, water containing dissolved organic matters, the LNAPL, and the DNAPL, facilitating further processing.
3. The present system has an automated control configuration, enabling automatic extraction and separation operations. It operates stably for extended periods, is simple and convenient to operate, requires minimal technical expertise from operators, and is conducive to the wide application of the system.

### BRIEF DESCRIPTION OF DRAWINGS

FIG. 1 is a structural schematic diagram of a system of the present invention.

FIG. 2 is a schematic diagram of a process flow of the system of the present invention.

FIG. 3 is a schematic diagram of an overall three-dimensional structure of the system of the present invention.

FIG. 4 is a structural exploded view of the system of the present invention.

FIG. 5 is one of schematic diagrams of external structures of a solid-Phase separation device.

FIG. 6 is another schematic diagram of the external structures of the solid-phase separation device.

FIG. 7 is a schematic diagram of internal structures of the solid-phase separation device.

FIG. 8 is a structural schematic diagram of a gas-phase separation device.

FIG. 9 is a schematic diagram of internal structures of an NAPL phase separation device.

FIG. 10 is a schematic diagram of an assembly of a rotating assembly in the NAPL phase separation device.

FIG. 11 is a cross-sectional view of the rotating assembly in the NAPL phase separation device.

FIG. 12 is a schematic diagram of a cross-sectional structure along A-A′, B-B′, C-C′, D-D′, E-E′, and F-F′ in FIG. 11.

FIG. 13 is a flowchart diagram showing automatic control of the solid-Phase separation device.

FIG. 14 is a flowchart of automatic control of the gas-phase separation device.

FIG. 15 is a flowchart diagram showing automatic control of the NAPL phase separation device.

FIG. 16 is a flowchart diagram showing an automatic control system for vacuum pumping device.

Reference numerals in the drawings are:
solid phase separation device a, wherein: extract inlet a-1, solid phase separation device shell a-2, first filter a-3-1, second filter a-3-2, third filter a-3-3, fourth filter a-3-4, flow meter a-4, first solid phase separation electrically controlled valve a-5-1, second solid phase separation electrically controlled valve a-5-2, third solid phase separation electrically controlled valve a-5-3, fourth solid phase separation electrically controlled valve a-5-4, solid phase separation level gauge a-6, water spray pipe a-7, spiral blade a-8, solid phase separation motor a-9, solid phase separation belt a-10, solid phase separation outlet a-11;
gas phase separation device b, comprising: gas phase separation inlet b-1, gas phase separation tank b-2, gas phase separation electrically controlled valve b-3, gas pressure sensor b-4, gas phase separation level gauge b-5, gas outlet b-6, centrifugal pump b-7, check valve b-8, and liquid outlet b-9;
NAPL phase separation device c, comprising: mixed liquid inlet c-1, casing c-2, NAPL phase separation motor c-3, NAPL phase separation belt c-4, rotating assembly c-5, separation pipe c-6, first NAPL phase separation electrically controlled valve c-7-1, second NAPL phase separation electrically controlled valve c-7-2, and third NAPL phase separation valve c-9, APL phase separation electrically controlled valve c-7-3, water outlet c-8, LNAPL outlet c-9, DNAPL outlet c-10, first electrode group c-11-1, second electrode group c-11-2, third electrode group c-11-3, first power supply slip ring c-12-1, second power supply slip ring c-12-2, third power supply slip ring c-12-3, rotating shaft center c-13, wherein the rotating assembly c-5 includes: bearing c-5-1, rotating housing c-5-2, rotating blade c-5-3, first base plate c-5-4, first central circular hole c-5-4-1, arc-shaped opening c-5-4-2, first circular opening c-5-4-3, second base plate c-5-5, second central circular hole c-5-5-1, edge c-5-5-2, second circular opening c-5-5-3, third base plate c-5-6, third central circular hole c-5-6-1, rectangular groove c-5-6-2, centrifuge zone inlet c-5-7, first flow channel c-5-8, second flow channel c-5-9, third flow channel c-5-10, first connecting pipe c-5-11, second connecting pipe c-5-12, third connecting pipe c-5-13;
Vacuum pumping device d, of which: gas inlet d-1;
VOC treatment device e; and
Control cabinet f.

### EMBODIMENTS

The technical solution provided in the present invention will be further described below with reference to specific embodiments and accompanying drawings. The advantages and features of the present invention will become clearer with the following description.

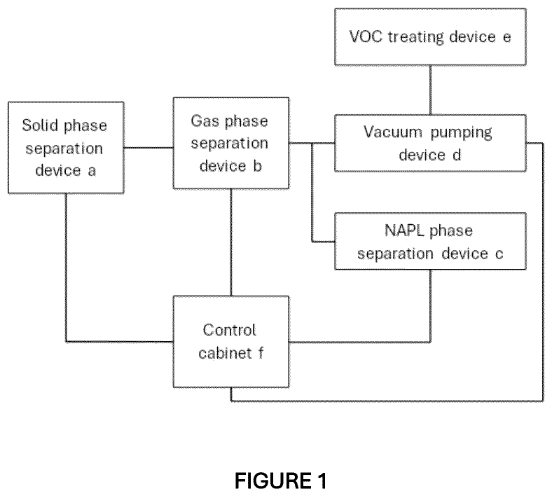

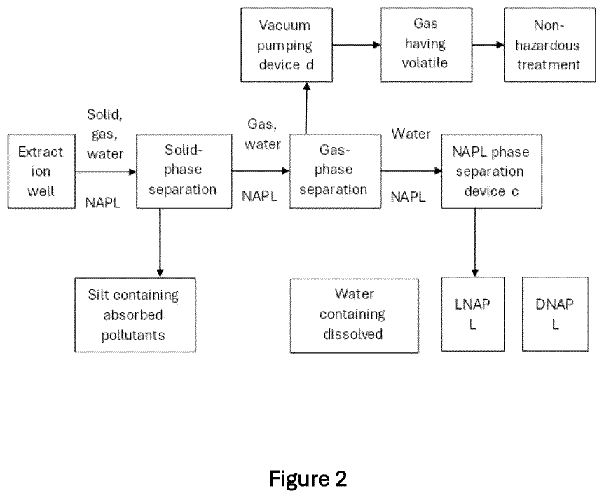

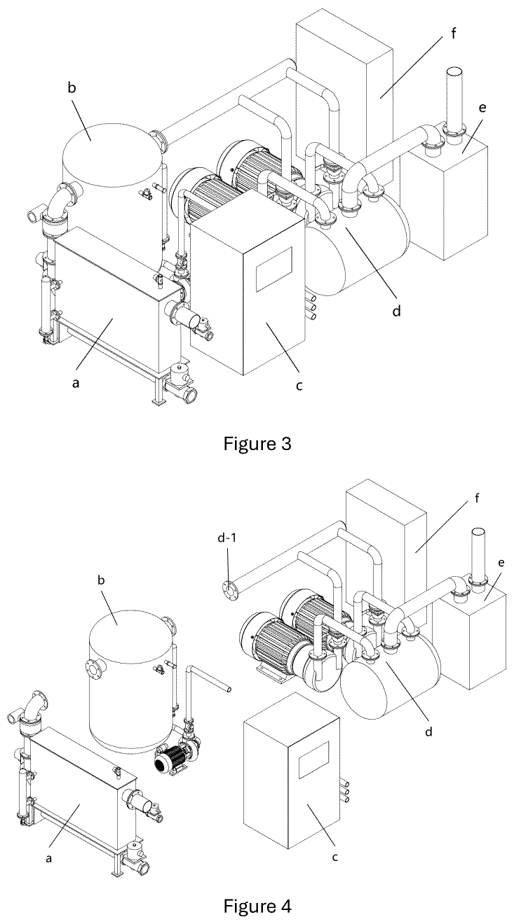

As shown in FIGS. 1, 2, 3, and 4, an automated multiphase extraction and separation system for contaminated sites comprises: a solid-phase separation device a, a gas-phase separation device b, a non-aqueous phase liquids (NAPL) phase separation device c, a vacuum pumping device d, a volatile organic compound (VOC) treatment device e, and a control cabinet f, wherein:
the solid-phase separation device a is configured to separate silt in adsorbed organic matters from extracts; the extracts after silt separation are transported to the gas-phase separation device b;
the gas-phase separation device b is configured to separate gases in volatile organic compounds from the extracts, while water and non-aqueous phase liquids NAPL containing dissolved organic matters are pumped to the NAPL phase separation device c;
the NAPL phase separation device c is configured to separate water containing dissolved organic matters, light non-aqueous liquids (LNAPL), and heavy non-AQUEOUS liquids (DNAPL);
the vacuum pumping device d provides negative pressure for multiphase extraction, extracting the gases containing volatile organic compounds from a tank of the gas phase separation device b, which is then purified by the VOC treatment device e before being discharged;
the control cabinet f is connected to the solid phase separation device a, the gas phase separation device b, the NAPL phase separation device c, and the vacuum pumping device d, and is used to automate multiphase extraction and separation operations.

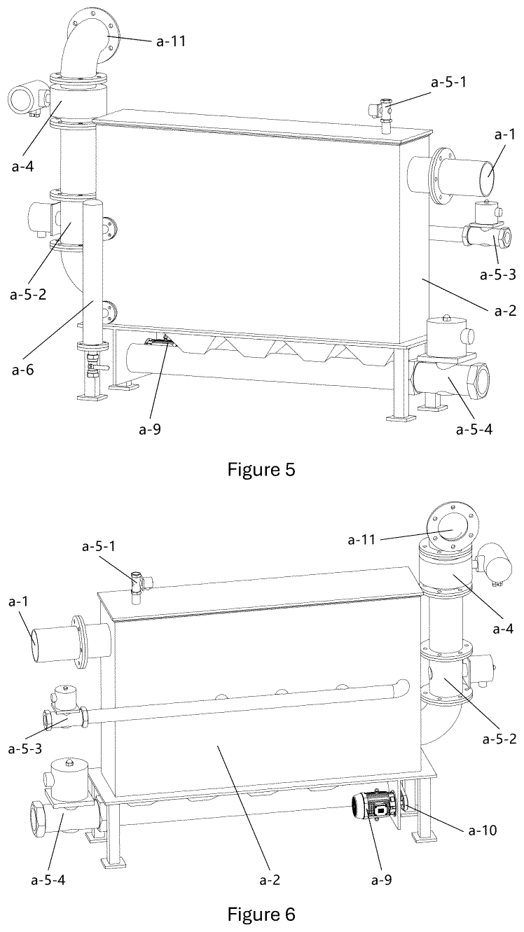

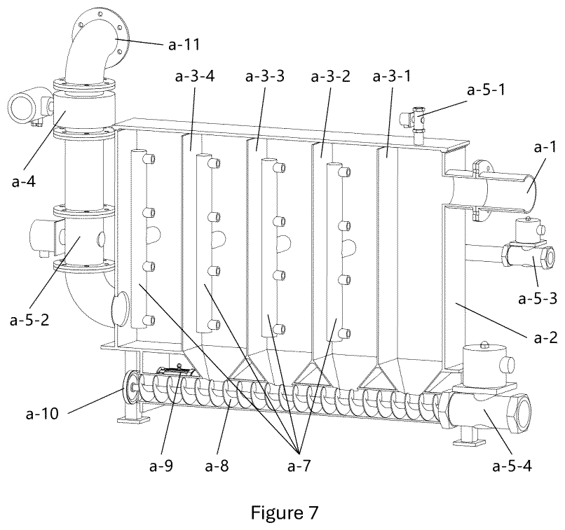

The solid-phase separation device a is configured to separate the silt containing adsorbed organic matters from the extracts, comprising: an extract inlet a-1, a solid-phase separation device shell a-2, a filter, a flow meter a-4, electrically controlled valves, a solid-phase separation level gauge a-6, a water spray pipe a-7, a spiral blade a-8, a solid-phase separation motor a-9, a solid-phase separation belt a-10, and a solid-phase separation outlet a-11, as shown in FIGS. 5, 6, and 7, wherein:
four electrically controlled valves are configured: a first solid-phase separation electrically controlled valve a-5-1, a second solid-phase separation electrically controlled valve a-5-2, a third solid-phase separation electrically controlled valve a-5-1, and a fourth solid-phase separation electrically controlled valve a-5-4; the first solid-phase separation electrically controlled valve a-5-1 is located on a top portion of the solid-phase separation device shell a-2, used to regulate internal gas pressure of the solid-phase separation device;
the extract inlet a-1 is located on one side of the solid-phase separation device shell a-2, communicating with an extraction well (not shown in the figure);
the solid-phase separation outlet a-11 is located on another side of the solid-phase separation device shell a-2, and the flow meter a-4 and the second solid-phase separation electrically controlled valve a-5-2 are installed at a front end of the solid-phase separation outlet a-11 of the gas phase separation device b;
four filters are configured, according to pore sizes, the filters are designated as a first filter a-3-1, a second filter a-3-2, a third filter a-3-3, and a fourth filter a-3-4 and the filters are used for multi-stage filtration of the silt containing adsorbed organic matters and are evenly arranged sequentially within the solid-phase separation device shell a-2; the first filter a-3-1 is located near the extract inlet a-1;
four water spray pipes a-7 are located behind each of the filters and connected to an external water source via the third solid-phase separation electrically controlled valve a-5-3 for spraying water to clean the filters. Spiral blades a-8 are located at a bottom portion of the solid-phase separation device shell a-2. One end of the spiral blade a-8 is equipped with the fourth solid-phase separation electrically controlled valve a-5-4 for discharging silt. Another end of the spiral blade a-8 is connected to an output shaft of the solid-phase separation motor a-9 via a solid-phase separation belt a-10. The solid-phase separation motor a-9 provides rotational power to the spiral blade a-8 through the solid-phase separation belt a-10. Rotation of the spiral blade a-8 discharges the silt containing adsorbed organic matters through the fourth solid-phase separation electrically controlled valve a-5-4. The level gauge a-6 is used to monitor a liquid level inside the solid-phase separation device and is arranged on the solid-phase separation device shell a-2.

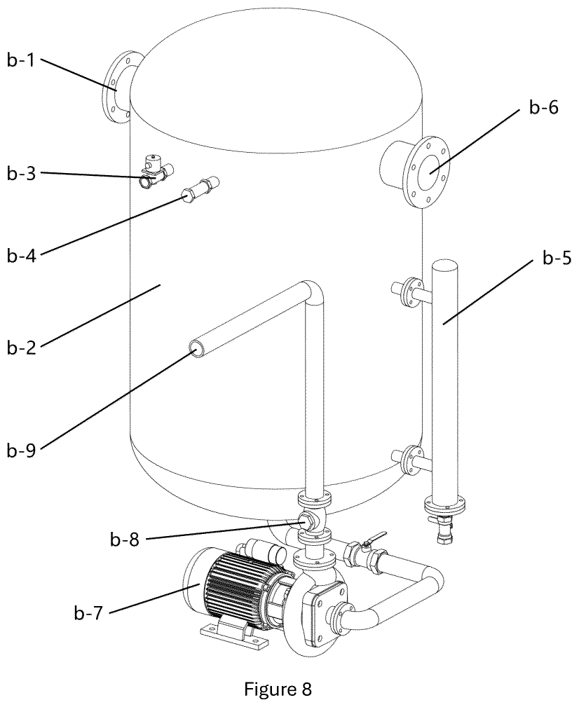

The gas phase separation device b is used to separate the gases containing volatile organic compounds from the extract, and comprises:
a gas phase separation inlet b-1, a tank b-2, a gas phase separation electrically controlled valve b-3, a pressure sensor b-4, a gas phase separation level gauge b-5, a gas outlet b-6, a centrifugal pump b-7, a check valve b-8, and a liquid outlet b-9, as shown in FIG. 8.

Specifically: the gas phase separation inlet b-1 and the gas outlet b-6 are located at an upper end of the tank b-2. The gas phase separation inlet b-1 is connected to the solid phase separation outlet a-11 of the solid phase separation device a, the gas outlet b-6 is connected to the gas inlet of the vacuum pumping device d, and the liquid outlet b-9 is connected to the mixed liquid inlet c-1 of the c-NAPL phase separation device;
the gas phase separation electrically controlled valve b-3 is arranged on an upper side of the tank b-2, and is configured to regulate the gas pressure inside the tank;
the gas pressure sensor b-4 is arranged on the upper side of the tank b-2, used to monitor the gas pressure inside the tank;
the gas phase separation level gauge b-5 is arranged on a side of the tank b-2, used to monitor a liquid level inside the tank;
a bottom portion of the tank b-2 is connected to the inlet of the centrifugal pump b-7 via at least one pipe; an outlet of the centrifugal pump b-7 is connected to the liquid outlet b-9; a check valve b-8 is installed between the outlet of the centrifugal pump b-7 and the liquid outlet b-9; after passing through the check valve b-8, the liquid is discharged through the liquid outlet b-9; the liquid outlet b-9 is connected to the mixed liquid inlet c-1 of the NAPL phase separation device c; the centrifugal pump b-7 provides power during liquid discharging, and the check valve b-8 prevents liquid backflow.

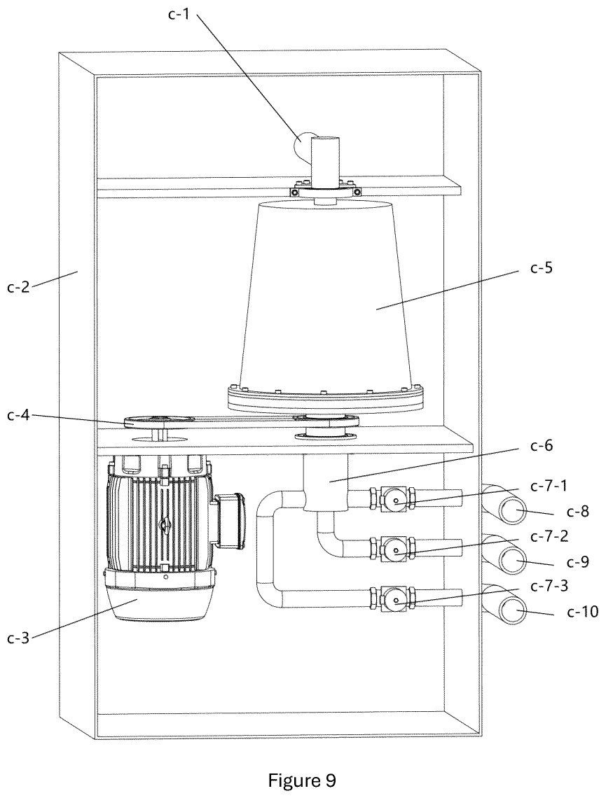

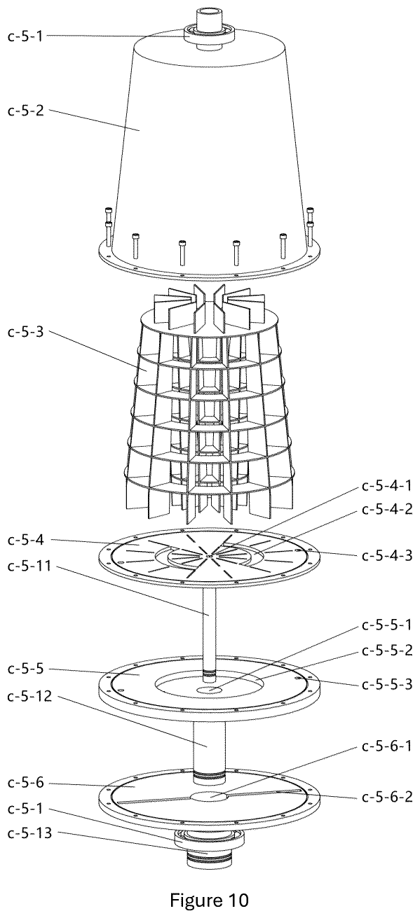

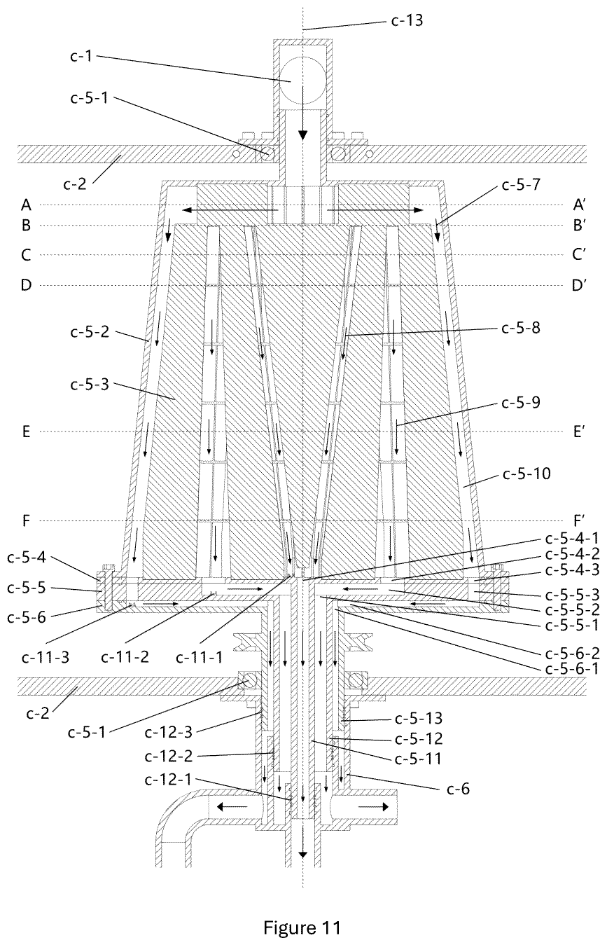

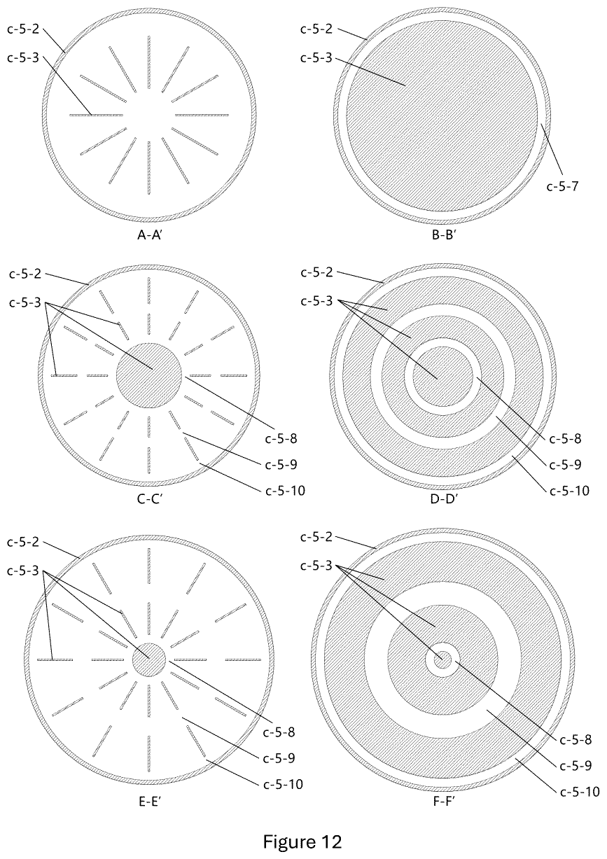

The NAPL phase separation device c is used to separate water containing dissolved organic matters, light non-aqueous liquids (LNAPL), and heavy non-aqueous liquids (DNAPL), and comprises: a mixed liquid inlet c-1, a device housing c-2, an NAPL phase separation motor c-3, an NAPL phase separation belt c-4, a rotating assembly c-5, a separation tube c-6, a first NAPL phase separation electrically controlled valve c-7-1, a second NAPL phase separation electrically controlled valve c-7-2, a third NAPL phase separation electrically controlled valve c-7-3, a water outlet c-8, and an LNAPL outlet c-9.-9, DNAPL outlet c-10, a first electrode group c-11-1, a second electrode group c-11-2, a third electrode group c-11-3, a first power supply slip ring c-12-1, a second power supply slip ring c-12-2, a third power supply slip ring c-12-3, as shown in FIGS. 9, 10, 11, and 12, wherein:
the mixed liquid inlet c-1 is located at the upper end of the rotating assembly c-5, and the mixed liquid inlet c-1 is connected to the liquid outlet b-9 in the gas phase separation device b; the rotating assembly c-5 is installed inside the casing c-2, and an upper part of the rotating assembly c-5 is connected to the mixed liquid inlet c-1, and a lower part thereof is connected to the separation pipe c-6; the rotating assembly c-5 is used for high-speed rotation to achieve separation of the water containing dissolved organic matters, light non-aqueous phase liquids (LNAPL) and heavy non-aqueous phase liquids (DNAPL), comprising a bearing c-5-1, a rotating housing c-5-2, a rotating blade c-5-3, a first base plate c-5-4, a second base plate c-5-5, a third base plate c-5-6, a first connecting pipe c-5-11, a second connecting pipe c-5-12, and a third connecting pipe c-5-13; the rotating housing c-5-2 and the first base plate c-5-4 are provided with grooves; a lower part of the rotating blade c-5-3 is inserted into the groove in the first base plate c-5-4, and the upper part of the rotating blade c-5-3 is inserted into the groove in the rotating housing c-5-2; all of the rotating housing c-5-2, the rotating blade c-5-3, the first base plate c-5-4, the second base plate c-5-5, and the third base plate c-5-6 are fixed together using bolts; a centrifugal inlet and three independent flow channels are formed inside the rotating assembly; and two bearings c-5-1 are installed at the top and bottom of this whole assembly, thus forming the rotating assembly c-5.

Furthermore, for the rotating assembly c-5:
the rotating housing c-5-2 comprises a frustum-shaped structure, narrower at a top portion and wider at a bottom portion;
a centrifugal zone inlet c-5-7 is provided between a top edge of the rotating blade c-5-3 and the rotating housing c-5-2;

The rotating blade c-5-3 comprises a grid structure, with a first flow channel c-5-8 and a second flow channel c-5-9 inside, and a third flow channel c-5-10 is provided between the rotating blade c-5-3 and a side wall of the rotating housing c-5-2; the three flow channels are interconnected in a horizontal direction via a grid structure of the rotating blade c-5-5;
the first base plate c-5-4: a first circular hole c-5-4-1 is provided in a center thereof, communicating with the first flow channel c-5-8 inside the rotating blade c-5-3; an arc-shaped opening c-5-4-2 is provided in an intermediate portion thereof, communicating with the second flow channel c-5-9 inside the rotating blade c-5-3; a first circular opening c-5-4-3 is provided at an edge thereof, communicating with the third flow channel c-5-10 inside the rotating blade c-5-3;
the second base plate c-5-5: a second circular hole c-5-5-1 is provided in a center thereof, and an edge c-5-5-2 is provided along the second circular hole c-5-5-1; the edge c-5-5-2 is opposite to and communicates with the arc-shaped opening c-5-4-2 of the first base plate c-5-4, and then communicates with the second flow channel c-5-9 inside the rotating blade c-5-3; a second circular opening c-5-5-3 is provided at an edge thereof, and the second circular opening c-5-5-3 is the same as the first circular opening c-5-4-3 at the edge of the first base plate c-5-4; and the first base plate c-5-6 is connected to the third flow channel c-5-10 inside the rotating blade c-5-3;

The third base plate c-5-6 has a central third circular hole c-5-6-1, and a rectangular groove c-5-6-2 is provided radially outward along the edge of the third circular hole c-5-6-1. The rectangular groove c-5-6-2 is connected to the circular opening c-5-5-3 at the edge of the second base plate c-5-5, and thus to the third flow channel c-5-10 inside the rotating blade c-5-3;
diameters of the first connecting pipe c-5-11, the second connecting pipe c-5-12, and the third connecting pipe c-5-13 increase sequentially;
specifically: the first connecting pipe c-5-11 is connected to a bottom portion of the first base plate c-5-4 and communicates with the first central circular hole c-5-4-1; the second connecting pipe c-5-12 is connected to a bottom portion of the second base plate c-5-5 and communicates with the second central circular hole c-5-5-1; and the third connecting pipe c-5-13 is connected to a bottom portion of the third base plate c-5-6 and communicates with the third central circular hole c-5-6-1;

The above three connecting pipes are nested sequentially with gaps between adjacent inner and outer walls; sealing measures are provided at the connections between the three connecting pipes and the base plates; finally:
the first connecting pipe c-5-11 connects sequentially to the first circular hole c-5-4-1 in the center of the first base plate c-5-4, and to the first flow channel c-5-8 inside the rotating blade c-5-3, forming a complete flow channel, namely an LNAPL flow channel, used to discharge LNAPLs;
a gap between an inner wall of the second connecting pipe c-5-12 and an outer wall of the first connecting pipe c-5-11 forms a flow channel, the second connecting pipe c-5-12 sequentially connects to the second circular hole c-5-5-1 in the center of the second base plate c-5-5, the edge c-5-5-2, the arc-shaped opening c-5-4-2 in the middle of the first base plate c-5-4, and the second flow channel c-5-9 inside the rotating blade c-5-3, forming a complete flow channel, that is, a water flow channel, used to discharge the water containing dissolved organic matters;
the inner wall of the third connecting pipe c-5-13 and the outer wall of the second connecting pipe c-5-12 form a flow channel, the third connecting pipe c-5-13 sequentially connects to the third circular hole c-5-6-1 at the center of the third base plate c-5-6, the rectangular groove c-5-6-2, the second circular opening c-5-5-3 on the edge of the second base plate c-5-5, the first circular opening c-5-4-3 on the edge of the first base plate c-5-4, and the third flow channel c-5-10 inside the rotating blade c-5-3, forming a complete flow channel, namely the DNAPL flow channel, used to discharge DNAPLs.
the separation tube c-6 contains three outlet channels, which are respectively connected to the three complete flow channels (the LNAPL channel, the water channel, and the DNAPL channel) of the rotating assembly c-5; therefore, the separation tube c-6 outputs in three directions: LNAPLs are discharged downwards through the separation tube c-6, and then discharged from the LNAPL outlet c-9 through the second NAPL phase separation control valve c-7-2; the water containing dissolved organic matters is discharged to the right through the separation tube c-6, and then discharged from water outlet c-8 through the first NAPL phase separation control valve c-7-1; the DNAPLs are discharged to the left through the separation tube c-6, and then discharged from the DNAPL outlet c-10 through the third NAPL phase separation control valve c-7-3;
the first electrode group c-11-1, the second electrode group c-11-2, and the third electrode group c-11-3 are respectively arranged on the first base plate c-5-4, the second base plate c-5-5, and the third base plate c-5-6, and are used to measure liquid resistivity to monitor the separation purity (the resistivity of the LNAPLs and the DNAPLs is high, while that of water containing dissolved organic matter is low); the three electrode groups are powered by three sets of power supply slip rings:
the first power supply slip ring c-12-1, the second power supply slip ring c-12-2, and the third power supply slip ring c-12-3. In one embodiment, the first power supply slip ring c-12-1 is located between the outer wall of the first connecting pipe c-5-11 and the inner wall of the separation pipe c-6; the second power supply slip ring c-12-2 is located between the outer wall of the second connecting pipe c-5-12 and the inner wall of the separation pipe c-6; and the third power supply slip ring c-12-3 is located between the outer wall of the first connecting pipe c-5-13 and the separation pipe c-6;
the NAPL phase separation motor c-3 is arranged inside the casing c-2, and an output shaft thereof is connected to the rotating assembly c-5 via the NAPL phase separation belt c-4; the NAPL phase separation motor c-3 provides power to the rotating assembly c-5 through the NAPL phase separation belt c-4.

The principle of water and NAPL phase separation is as follows:

Water and NAPLs enter the rotating assembly c-5 through the mixed liquid inlet c-1. The mixed liquid then enters the centrifugal zone below the rotating blade c-5-3 through the centrifugal zone inlet c-5-7 at the top edge of the rotating blade c-5-3. The NAPL phase separation motor c-3 provides power to make the rotating assembly c-5 rotate at high speed. The mixed liquid inside the centrifugal zone is driven to rotate at high speed by the rotating blade c-5-3. Since LNAPL has a lower density than water, the LNAPLs in the mixed liquids will transfer towards the center of the rotating shaft c-13. The LNAPLs are transferred to the first flow channel c-5-8 through the grid of rotating blade c-5-3. Similarly, since the DNAPLs have a higher density than water, the DNAPLs in the mixed liquid will move away from the rotation axis center c-13, meaning the LNAPLs are transferred to the third flow channel c-5-10 through the grid of rotating blade c-5-3. Water is located between the LNAPLs and the DNAPLs. Thus, the LNAPLs, the DNAPLs, and water are separated, with the order from the rotation axis center c-13 outwards being the LNAPLs, water, and the DNAPLs. The inclined sidewall of the rotating shell c-5-2 facilitates this process. At the outer edge of the bottom of the centrifugation zone, where the DNAPLs converges, the rotating blade c-5-3 has a conical structure at a center thereof with an apex pointing downwards, which helps the LNAPLs converge at the center of the rotating axis at the bottom of the centrifugation zone.

Compared to water, LNAPL and DNAPL have higher resistivity. The resistivity of the LNAPL at its position is monitored by the first electrode group c-11-1. When the resistivity reaches the set threshold for separating LNAPL, the second NAPL phase separation electrically controlled valve c-7-2 opens, allowing LNAPL to flow through the LNAPL channel and exit from the LNAPL outlet c-9. Similarly, the resistivity of DNAPL is monitored by the third electrode group c-11-3. When the resistivity reaches the set threshold for DNAPL separation, the third NAPL phase separation electrically controlled valve c-7-3 opens, allowing DNAPL to flow through the DNAPL channel and be discharged from the DNAPL outlet c-10. The resistivity of water is monitored by the second electrode group c-11-2. When the resistivity reaches the set threshold for water separation, the first NAPL phase separation electrically controlled valve c-7-1 opens, allowing water containing dissolved organic matter to flow through the water channel and be discharged from the water outlet c-8.

The vacuum pumping device d provides negative pressure for multiphase extraction. It includes a gas inlet d-1 and a gas outlet. The gas inlet d-1 is connected to the gas outlet b-6 of the gas phase separation device b, and the gas outlet is connected to the VOC treatment device e. The vacuum pumping device d extracts the gas containing volatile organic compounds from the tank b-2 of the gas phase separation device b, which is then purified by the VOC treatment device e before being discharged.

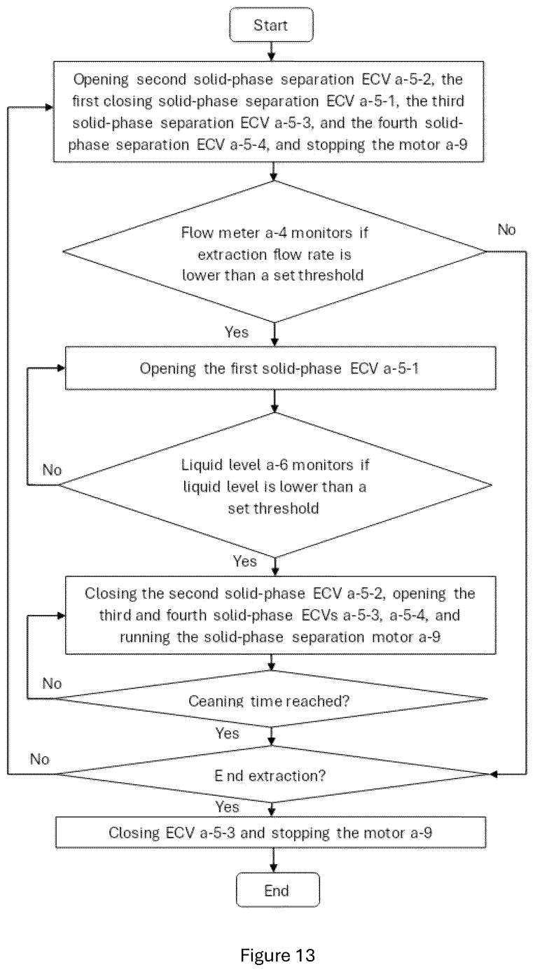

The control cabinet f automates multiphase extraction and separation operation. It is connected to the solid-phase separation unit a, the gas-phase separation unit b, the NAPL phase separation unit c, and the vacuum pumping device d. It acquires information from flow meters, level gauges, pressure sensors, and electrode arrays, and operates the electrically controlled valves, motors, centrifugal pumps, and vacuum pumping device d. Specifically: The control cabinet f is connected to the flow meter a-4, the solid-phase separation level gauge a-6, the electrically controlled valves (the first solid-phase separation electrically controlled valve a-5-1, the second solid-phase separation electrically controlled valve a-5-2, the third solid-phase separation electrically controlled valve a-5-3, and the fourth solid-phase separation electrically controlled valve a-5-4), and the solid-phase separation motor a-9 of the solid-phase separation unit a. It acquires the extraction flow rate detected by flow meter a-4 and the liquid level height detected by solid-phase separation level gauge a-6, and controls the electrically controlled valves and solid-phase separation motor a-9 to automatically clean the sediment on the filter. The specific automatic control process is shown in FIG. 13;

At the start of the extraction operation, the control states of each of the electrically controlled valves and the solid-phase separation motor a-9 are as follows: the second solid-phase separation electrically controlled valve a-5-2 is opened, the first solid-phase separation electrically controlled valve a-5-1, the third solid-phase separation electrically controlled valve a-5-3, and the fourth solid-phase separation electrically controlled valve a-5-4 are closed, and the solid-phase separation motor a-9 is stopped; at this time, the liquid in the solid-phase separation device a is discharged through the solid-phase separation outlet a-11 and transported to the gas-phase separation device b, and the extraction flow rate is monitored by the flow meter a-4;

During the extraction operation, when the flow meter a-4 detects the extraction flow rate falls below the set threshold, a cleaning process is initiated and this process involves:
opening the first solid-phase separation electrically controlled valve a-5-1 to return the solid-phase separation device a to normal pressure. At this time, water, air, and NAPL continue to slowly enter the gas-phase separation device b. The liquid level is monitored by the solid-phase separation level gauge a-6. When the liquid level falls below the set solid-phase separation level threshold, the second solid-phase separation electrically controlled valve a-5-2 is closed, and the third and fourth solid-phase separation electrically controlled valves a-5-3 and a-5-4 are opened. External water is sprayed onto the filter through the spray pipe a-7 to rinse away the silt and the solid-phase separation motor a-9 starts operating, using spiral blades a-8 to discharge the silt containing adsorbed organic matters through the opening of the fourth solid-phase separation electrically controlled valve a-5-4. When the rinsing time reaches the set rinsing duration, the third solid-phase separation electrically controlled valve a-5-3 and the fourth solid-phase separation electrically controlled valve a-5-4 are closed, and the solid-phase separation motor a-9 stops operating, ending the cleaning process. After the cleaning process is completed, if further extraction is required, the states of all the electrically controlled valves and the solid-phase separation motor a-9 are returned to their initial states at the start of the extraction operation, and the extraction operation continues.

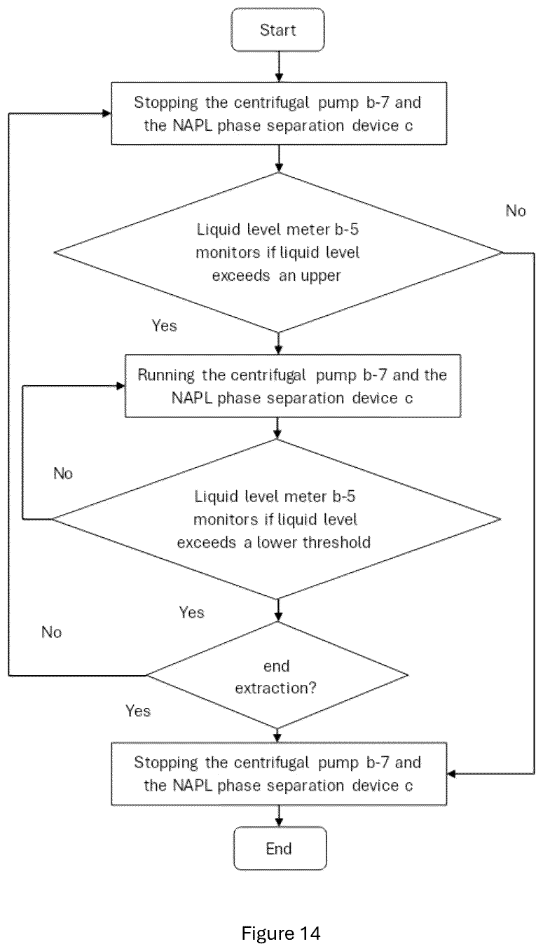

The control cabinet f is connected to the gas phase separation level gauge b-5, the pressure sensor b-4, the gas phase separation electrically controlled valve b-3, and the centrifugal pump b-7 of the gas phase separation device b. It acquires the pressure data from pressure sensor b-4 and the liquid level height detected by gas phase separation level gauge b-5, controls the gas phase separation electrically controlled valve b-3 to adjust the pressure inside tank b-2, and controls the operation of the centrifugal pump b-7 to pump the water and NAPL from the tank b-2 to the NAPL phase separation device c. The specific automatic control flow is shown in FIG. 14.

At the start of the extraction operation, the centrifugal pump b-7 stops, the NAPL phase separation device c stops, and the liquid level in tank b-2 is monitored by the gas phase separation level gauge b-5. When the liquid level is higher than the upper limit of the set gas phase separation liquid level range, the NAPL phase separation process begins, the centrifugal pump b-7 runs, and the NAPL phase separation device c runs synchronously. When the gas phase separation level gauge b-5 detects that the liquid level in the tank b-2 is lower than the lower limit of the set gas phase separation liquid level range, or when it is necessary to stop the extraction operation, the centrifugal pump b-7 stops, the NAPL phase separation device c stops, and the NAPL phase separation process ends.

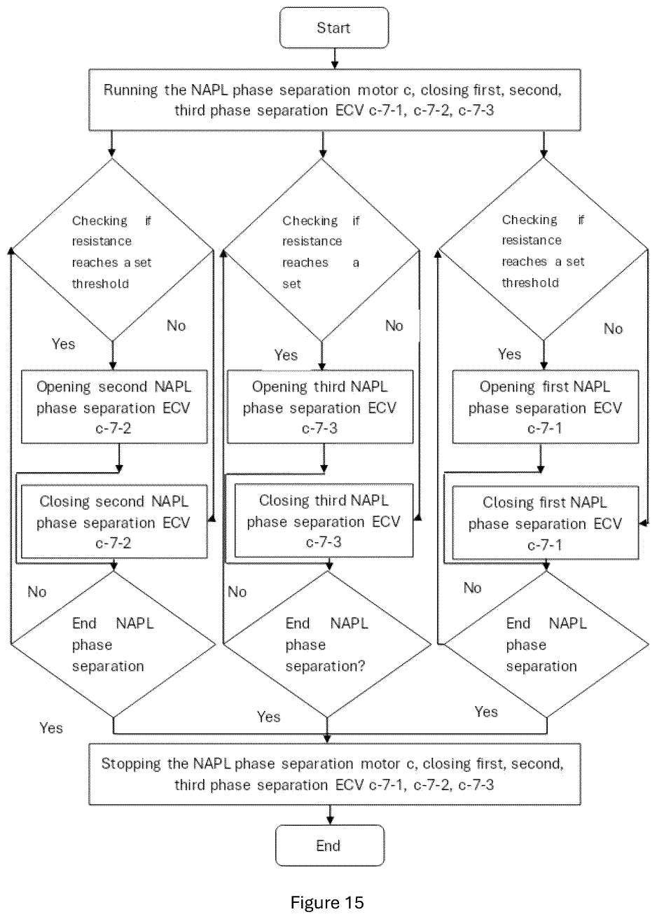

The control cabinet f is connected to the electrode groups (the first electrode group c-11-1, the second electrode group c-11-2, and the third electrode group c-11-3), electrically controlled valves (the first NAPL phase separation electrically controlled valve c-7-1, the second NAPL phase separation electrically controlled valve c-7-2, and the third NAPL phase separation electrically controlled valve c-7-3), and the NAPL phase separation motor c-3 of the NAPL phase separation device c. It acquires the resistivity information of the electrode groups and controls the electrically controlled valves and the NAPL phase separation motor c-3 to achieve separation of the water containing dissolved organic matters, light non-aqueous phase liquids (LNAPL), and heavy non-aqueous phase liquids (DNAPL). The specific automatic control flow is shown in FIG. 15.

At the start of the NAPL phase separation process, the NAPL phase separation motor c-3 starts running, and the first NAPL phase separation electrically controlled valve c-7-1, the second NAPL phase separation electrically controlled valve c-7-2, and the third NAPL phase separation electrically controlled valve c-7-3 are closed. The first electrode group c-11-1, the second electrode group (c-11-2) and the third electrode group (c-11-3) monitor resistivity.

When the resistivity detected by the first electrode group (c-11-1) reaches the set resistivity threshold for separating the LNAPL, the second NAPL phase separation electrically controlled valve (c-7-2) opens, discharging the LNAPL.

When the resistivity detected by the third electrode group (c-11-3) reaches the set resistivity threshold for separating the DNAPL, the third NAPL phase separation electrically controlled valve (c-7-3) opens, discharging the DNAPL.

When the resistivity detected by the second electrode group (c-11-2) reaches the set resistivity threshold for separating water, the first NAPL phase separation electrically controlled valve (c-7-1) opens, discharging the water containing dissolved organic matters.

If the NAPL phase separation process ends, the NAPL phase separation motor (c-3) stops running, and the first NAPL phase separation electrically controlled valve (c-7-1), the second NAPL phase separation electrically controlled valve (c-7-2), and the third NAPL phase separation electrically controlled valve (c-7-3) close.

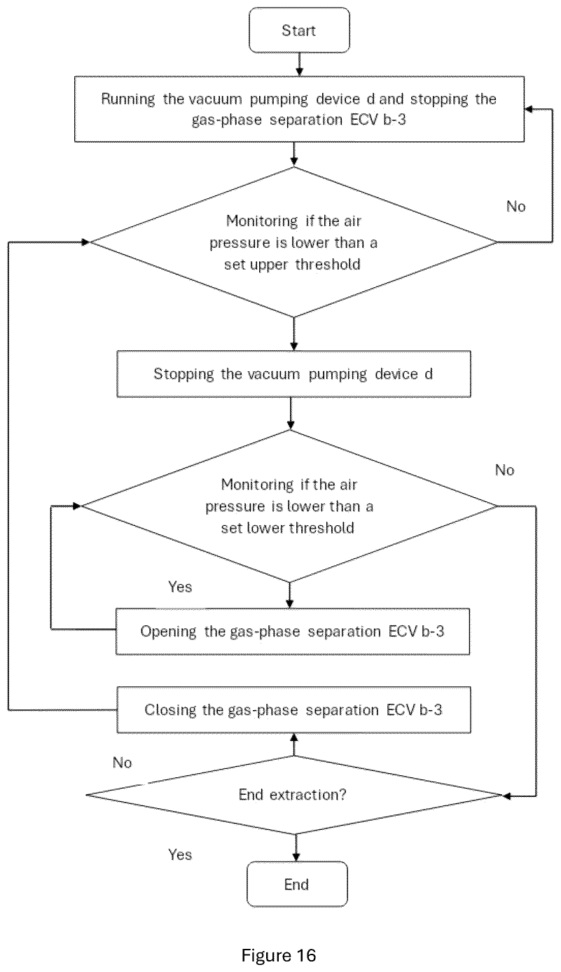

The control cabinet f is connected to vacuum pumping device d, controlling the operation of the vacuum pumping device. The specific automatic control process is shown in FIG. 16.

Before the extraction operation begins, the extraction negative pressure range is set in the control cabinet. The pressure is set to be a negative value, including the lower limit and the upper limit of the pressure range. The extraction negative pressure is adjusted by the vacuum pumping device d to be lower than the upper limit of the set pressure range, and by the gas phase separation electrically controlled valve b-3 to be adjusted to be higher than the lower limit of the set pressure range.

When the extraction operation begins, the vacuum pumping device d starts running, the gas phase separation electrically controlled valve b-3 closes, and the pressure sensor b-4 monitors the pressure inside the tank b-2. When the pressure inside tank b-2 falls below the upper limit of the set pressure range, the vacuum pumping device d stops operating. If the pressure inside tank b-2 falls below the lower limit of the set pressure range, the gas phase separation control valve b-3 opens, increasing the pressure until it exceeds the lower limit of the set pressure range. Then, it determines whether to terminate the extraction operation. If the extraction operation is not terminated, the gas phase separation control valve b-3 closes, and the pressure sensor b-4 monitors the pressure status inside tank b-2 again. If the extraction operation is terminated, the program ends.

Furthermore, the control cabinet is equipped with a touchscreen with buttons for parameter setting, starting extraction, ending extraction, and for human-machine interaction.

A method of using the above-mentioned automated multiphase extraction and separation system for contaminated sites comprising:
Step 1: installing the system and setting parameters via the control cabinet touchscreen.
Step 2: starting extraction by clicking a “Start Extraction” button on the control cabinet touchscreen to automatically perform multiphase extraction and separation and extraction will end upon completion.
Step 3: ending extraction by clicking an “End Extraction” button on the control cabinet touchscreen; the system will stop running and automatically release the extraction negative pressure.

During application, connect the extract inlet a-1 of the solid phase separation device a to the extraction well. Multiple extraction wells can be connected simultaneously. The third solid phase separation electrically controlled valve a-5-3 is connected to an external water source.

Before the multiphase extraction and separation operation begins, status settings of each of the electrically controlled valves are as follows: for the solid phase separation device a, the first solid phase separation electrically controlled valve a-5-1, the third solid phase separation electrically controlled valve a-5-3, and the fourth solid phase separation electrically controlled valve a-5-4 are closed; the second solid phase separation electrically controlled valve a-5-2 is open; for the gas phase separation device b, the gas phase separation electrically controlled valve b-3 is closed; for the NAPL phase separation device c, the first NAPL phase separation electrically controlled valve c-7-1, the second NAPL phase separation electrically controlled valve c-7-2, and the third NAPL phase separation electrically controlled valve c-7-3 are closed.

Specifically, in step 1, parameters are set via the control cabinet touchscreen, including the extraction negative pressure range (lower limit and upper limit of the gas pressure range), the flow rate threshold, solid phase separation liquid level threshold, cleaning time, gas phase separation liquid level range (lower limit and upper limit of the gas phase separation liquid level range), resistivity threshold for separating LNAPL, resistivity threshold for separating DNAPL, and resistivity threshold for separating water, etc.

After setting the parameters in control cabinet f, click the “Start Extraction” button on the touchscreen to begin the extraction process. Specifically, step 2 includes:
2.1: The vacuum pumping device d operates, extracting air from the tank b-2 of the gas phase separation device b to reach the set extraction negative pressure range. Under vacuum pressure, the extract containing contaminants—water, air, silt, and NAPL—is drawn into the extract inlet a-1 of the solid phase separation device a.
2.2: After passing through multiple stages of filtration within the solid phase separation device a (using filters with decreasing pore sizes: the first filter a-3-1, the second filter a-3-2, the third filter a-3-3, and the fourth filter a-3-4), the silt containing adsorbed organic matter remains on the filters, while the water, air, and NAPL enter the gas phase separation device b.
After running for a certain period of time, the filter becomes clogged with silt, making it difficult for water, air, and NAPL to pass through, resulting in a decrease in the extraction flow rate. When the flow meter a-4 detects that the extraction flow rate is lower than the set flow rate threshold, it automatically starts cleaning the silt on the filter.
2.3: Water, air, and NAPL containing pollutants enter the gas phase separation device b through the gas phase separation inlet b-1. The water and NAPL are located at the bottom of the tank b-2, while the air at the top is extracted by the vacuum pump d through the gas outlet b-6 and discharged into the VOC treatment device e, where it is purified before being discharged.
When the gas phase separation level gauge b-5 detects that the liquid level in the tank b-2 has reached the upper limit of the set gas phase separation level range, the centrifugal pump b-7 and the NAPL phase separation device c start operating to separate LNAPL, DNAPL, and water. Specifically, in step 3, after the extraction operation is completed, clicking the “End Extraction” button on the touchscreen of the control cabinet f stops the system and automatically opens the gas phase separation electronically controlled valve b-3, allowing the inside of the tank b-2 to return to normal pressure.

The above description is merely a description of preferred embodiments of the present invention and is not intended to limit the scope of the present invention in any way. Any changes or modifications made by those skilled in the art based on the above-disclosed technical content should be considered as equivalent and valid embodiments, and all fall within the scope of protection of the technical solution of the present invention.

1. An automated multiphase extraction and separation system for contaminated sites, comprising a solid-phase separation device (a), a gas-phase separation device (b), an non-aqueous phase liquids (NAPL) phase separation device (c), a vacuum pumping device (d), a volatile organic compound (VOC) treatment device (e) and a control cabinet (f), wherein the solid-phase separation device (a) comprises an extract inlet (a-1), a solid-phase separation device shell (a-2), filters, a flow meter (a-4), electrically controlled valves, a solid-phase separation level gauge (a-6), water spray pipes (a-7), spiral blades (a-8), a solid-phase separation motor (a-9), a solid-phase separation belt (a-10) and a solid-phase separation outlet (a-11), wherein the filters are arranged evenly inside the solid-phase separation device shell (a-2) for multi-stage filtration of silt containing adsorbed organic matters; the water spray pipes (a-7) are located behind each of the filters to spray water and clean, and the spiral blades (a-8) are located at a bottom portion of the solid-phase separation device shell (a-2) to remove silt:
the solid-phase separation device (a) is configured for separating silt containing adsorbed organic matters from extracts, the extracts after silt separation being conveyed to the gas-phase separation device (b);
the gas-phase separation device (b) is configured for separating gas containing volatile organic compounds from the extracts, water containing dissolved organic matters and non-aqueous phase liquids (NAPL) being pumped into the NAPL phase separation device (c); the NAPL phase separation device (c) comprises a mixed liquid inlet (c-1), a device housing (c-2), a NAPL phase separation motor (c-3), a NAPL phase separation belt (c-4), a rotating assembly (c-5), a separation pipe (c-6), a first NAPL phase separation electrically controlled valve (c-7-1), a second NAPL phase separation electrically controlled valve (c-7-2), a third NAPL phase separation electrically controlled valve (c-7-3), a water outlet (c-8), an LNAPL outlet (c-9), a DNAPL outlet (c-10), a first electrode group (c-11-1), a second electrode group (c-11-2), a third electrode group (c-11-3), a first power supply slip ring (c-12-1), a second power supply slip ring (c-12-2) and a third power supply slip ring (c-12-3), wherein:
the mixed liquid inlet (c-1) is arranged at an upper end of the rotating assembly (c-5), and the mixed liquid inlet (c-1) is communicated with the liquid outlet in the gas-phase separation device (b);
the rotating assembly (c-5) is installed inside the device housing (c-2), the upper part of the rotating assembly (c-5) is communicated with the mixed liquid inlet (c-1), and a lower part of the rotating assembly (c-5) is connected to the separation pipe (c-6); the rotating assembly (c-5) comprises a bearing (c-5-1), a rotating housing (c-5-2), a rotating blade (c-5-3), a first base plate (c-5-4), a second base plate (c-5-5), a third base plate (c-5-6), a first connecting pipe (c-5-11), a second connecting pipe (c-5-12) and a third connecting pipe (c-5-13); the rotating housing (c-5-2) and the first base plate (c-5-4) are provided with grooves, a lower part of the rotating blade (c-5-3) is clamped into the groove of the first base plate (c-5-4), an upper part of the rotating blade (c-5-3) is clamped into the groove of the rotating housing (c-5-2), the rotating housing (c-5-2), the rotating blade (c-5-3), the first base plate (c-5-4), the second base plate (c-5-5) and the third base plate (c-5-6) are fixed together by bolts, a centrifuge zone inlet and three independent flow channels are formed inside the rotating assembly, and two bearings (c-5-1) are respectively installed at an upper part and a lower part thereof, thus forming the rotating assembly (c-5);
the separation pipes (c-6) output in three ways, and outputting respectively water, LNAPL and DNAPL;
the NAPL phase separation device (c) is configured for separating the water containing dissolved organic matters and NAPL into water, light non-aqueous phase liquids (LNAPL) and dense non-aqueous phase liquids (DNAPL);
the vacuum pumping device (d) provides negative pressure for multiphase extraction construction, extracts the gas containing volatile organic compounds from a tank body of the gas-phase separation device (b), extracted gas being purified by the VOC treatment device (e) before discharge; and
the control cabinet (f) is connected to the solid-phase separation device (a), the gas-phase separation device (b), the NAPL phase separation device (c) and the vacuum pumping device (d), and is used for realizing automated operation of multiphase extraction and separation operations.

2. The automated multiphase extraction and separation system for contaminated sites according to claim 1, wherein:
there are four electrically controlled valves, namely a first solid-phase separation electrically controlled valve (a-5-1), a second solid-phase separation electrically controlled valve (a-5-2), a third solid-phase separation electrically controlled valve (a-5-3) and a fourth solid-phase separation electrically controlled valve (a-5-4); the first solid-phase separation electrically controlled valve (a-5-1) is arranged on a top portion of the solid-phase separation device shell (a-2) and is used for adjusting air pressure inside the solid-phase separation device;
the extract inlet (a-1) is arranged on one side of the solid-phase separation device shell (a-2) and is communicated with an extraction well;
the solid-phase separation outlet (a-11) is arranged on another side of the solid-phase separation device shell (a-2), and the flow meter (a-4) and the second solid-phase separation electrically controlled valve (a-5-2) are arranged at a front end of the solid-phase separation outlet of the gas-phase separation device (b);
there are four filters, which are a first filter (a-3-1), a second filter (a-3-2), a third filter (a-3-3) and a fourth filter (a-3-4) in a descending order of pore sizes, are used for multi-stage filtration of the silt containing adsorbed organic matters, are sequentially and uniformly arranged in the solid-phase separation device shell (a-2), and the first filter (a-3-1) is adjacent to the extract inlet (a-1);
there are four water spray pipes (a-7), which are respectively arranged behind each of the filters, the four water spray pipes (a-7) are connected to an external water source through the third solid-phase separation electrically controlled valve (a-5-3) and are used for spraying water to the filters to clean the filters;
the spiral blade (a-8) is arranged at a bottom portion of the solid-phase separation device shell (a-2), one end of the spiral blade (a-8) is provided with the fourth solid-phase separation electrically controlled valve (a-5-4) for discharging silt, another end of the spiral blade (a-8) is connected to an output shaft of the solid-phase separation motor (a-9) through the solid-phase separation belt (a-10), the solid-phase separation motor (a-9) provides rotational power for the spiral blade (a-8) through the solid-phase separation belt (a-10), and the spiral blade (a-8) rotates to discharge flushed silt containing adsorbed organic matters through the fourth solid-phase separation electrically controlled valve (a-5-4);
the level gauge (a-6) is used for monitoring a liquid level inside the solid-phase separation device and is arranged on a side surface of the solid-phase separation device shell (a-2);
the flow meter (a-4), the solid-phase separation level gauge (a-6), the first solid-phase separation electrically controlled valve (a-5-1), the second solid-phase separation electrically controlled valve (a-5-2), the third solid-phase separation electrically controlled valve (a-5-3), the fourth solid-phase separation electrically controlled valve (a-5-4) and the solid-phase separation motor (a-9) of the solid-phase separation device (a) are all connected to the control cabinet (f).

3. The automated multiphase extraction and separation system for contaminated sites according to claim 1, wherein
the gas-phase separation device (b) comprises a gas-phase separation inlet (b-1), a tank body (b-2), a gas-phase separation electrically controlled valve (b-3), a gas pressure sensor (b-4), a gas-phase separation level gauge (b-5), a gas outlet (b-6), a centrifugal pump (b-7), a check valve (b-8) and a liquid outlet (b-9), wherein:
the gas-phase separation inlet (b-1) and the gas outlet (b-6) are arranged at an upper end of the tank body (b-2), the gas-phase separation inlet (b-1) is communicated with the solid-phase separation outlet of the solid-phase separation device (a), and the gas outlet (b-6) is communicated with the gas inlet of the vacuum pumping device (d);
the gas-phase separation electrically controlled valve (b-3) is arranged on an upper part of a side surface of the tank body (b-2) and is used for adjusting air pressure inside the tank body;
the gas pressure sensor (b-4) is arranged on the upper part of the side surface of the tank body (b-2) and is used for monitoring the air pressure inside the tank body;
the gas-phase separation level gauge (b-5) is arranged on the side surface of the tank body (b-2) and is used for monitoring a liquid level inside the tank body;
a bottom portion of the tank body (b-2) is communicated with the inlet of the centrifugal pump (b-7) through a pipeline, the outlet of the centrifugal pump (b-7) is connected to the liquid outlet (b-9), the check valve (b-8) is arranged between the outlet of the centrifugal pump (b-7) and the liquid outlet (b-9), the liquid outlet (b-9) is communicated with a mixed liquid inlet of the NAPL phase separation device (c), the centrifugal pump (b-7) is used for providing power during liquid discharge, and the check valve (b-8) is used for preventing liquid backflow; the gas-phase separation electrically controlled valve (b-3), the gas-phase separation level gauge (b-5), the gas pressure sensor (b-4) and the centrifugal pump (b-7) of the gas-phase separation device (b) are all connected to the control cabinet (f).

4. The automated multiphase extraction and separation system for contaminated sites according to claim 1, wherein
the separation pipe (c-6) has three output paths: the LNAPL is discharged downwards through the separation pipe (c-6) and then discharged from the LNAPL outlet (c-9) through the second NAPL phase separation electrically controlled valve (c-7-2); the water containing dissolved organic matters is discharged rightwards through the separation pipe (c-6) and then discharged from the water outlet (c-8) through the first NAPL phase separation electrically controlled valve (c-7-1); the DNAPL is discharged leftwards through the separation pipe (c-6) and then discharged from the DNAPL outlet (c-10) through the third NAPL phase separation electrically controlled valve (c-7-3);
the first electrode group (c-11-1), the second electrode group (c-11-2) and the third electrode group (c-11-3) are respectively arranged on the first base plate (c-5-4), the second base plate (c-5-5) and the third base plate (c-5-6), and the three electrode groups are respectively powered by three sets of power supply slip rings, namely the first power supply slip ring (c-12-1), the second power supply slip ring (c-12-2) and the third power supply slip ring (c-12-3);
the NAPL phase separation motor (c-3) is arranged inside the device housing (c-2), an output shaft of the NAPL phase separation motor (c-3) is connected to the rotating assembly (c-5) through the NAPL phase separation belt (c-4), and the NAPL phase separation motor (c-3) provides power for the rotating assembly (c-5) through the NAPL phase separation belt (c-4);
the first electrode group (c-11-1), the second electrode group (c-11-2), the third electrode group (c-11-3), the first NAPL phase separation electrically controlled valve (c-7-1), the second NAPL phase separation electrically controlled valve (c-7-2), the third NAPL phase separation electrically controlled valve (c-7-3) and the NAPL phase separation motor (c-3) of the NAPL phase separation device (c) are all connected to the control cabinet (f).

5. The automated multiphase extraction and separation system for contaminated sites according to claim 1, wherein
the vacuum pumping device (d) comprises a gas inlet (d-1) and a gas outlet, the gas inlet (d-1) is communicated with the gas outlet of the gas-phase separation device (b), and the gas outlet is communicated with the VOC treatment device (e); and
the vacuum pumping device (d) is further connected to the control cabinet (f).

6. The automated multiphase extraction and separation system for contaminated sites according to claim 2, wherein
the control cabinet (f) acquires an extraction flow rate detected by the flow meter (a-4) and a liquid level detected by the solid-phase separation level gauge (a-6), controls the electrically controlled valves and the solid-phase separation motor (a-9) to automatically clean the silt on the filters, specifically comprising:
at the start of extraction operations, controlling each of the electrically controlled valves and the solid-phase separation motor (a-9) as follows: opening the second solid-phase separation electrically controlled valve (a-5-2), closing the first solid-phase separation electrically controlled valve (a-5-1), the third solid-phase separation electrically controlled valve (a-5-3) and the fourth solid-phase separation electrically controlled valve (a-5-4), and stopping the solid-phase separation motor (a-9); at this time, a liquid in the solid-phase separation device (a) is discharged through the solid-phase separation outlet (a-11) and conveyed to the gas-phase separation device (b), and the extraction flow rate is monitored through the flow meter (a-4);
during the extraction operations, when the flow meter (a-4) detects that the extraction flow rate is lower than a set flow rate threshold, performing a cleaning process, the cleaning process being:
opening the first solid-phase separation electrically controlled valve (a-5-1) to return the solid-phase separation device (a) to a normal pressure state, at this time, water, air and NAPL continuing to enter the gas-phase separation device (b), monitoring the liquid level through the solid-phase separation level gauge (a-6), when the liquid level is lower than a set solid-phase separation liquid level threshold, closing the second solid-phase separation electrically controlled valve (a-5-2), opening the third solid-phase separation electrically controlled valve (a-5-3) and the fourth solid-phase separation electrically controlled valve (a-5-4), spraying water to the filters through the water spray pipes (a-7) by the external water source to flush the silt, starting the solid-phase separation motor (a-9), discharging the silt containing adsorbed organic matters through an opening of the fourth solid-phase separation electrically controlled valve (a-5-4) by the spiral blade (a-8), when flushing time reaches a set flushing duration, closing the third solid-phase separation electrically controlled valve (a-5-3) and the fourth solid-phase separation electrically controlled valve (a-5-4), stopping the solid-phase separation motor (a-9), and ending cleaning; after cleaning, if the extraction operation needs to be continued, controlling each of the electrically controlled valves and the solid-phase separation motor (a-9) to be resume operation at the start of the extraction operation, and continuing to perform the extraction operation.

7. The automated multiphase extraction and separation system for contaminated sites according to claim 3, wherein
the control cabinet (f) acquires air pressure data of the air pressure sensor (b-4) and the liquid level detected by the gas-phase separation level gauge (b-5), controls the gas-phase separation electrically controlled valve (b-3) to adjust the air pressure inside the tank body (b-2), controls the centrifugal pump (b-7) to pump the water and NAPL in the tank body (b-2) to the NAPL phase separation device (c), specifically comprising:
at the start of the extraction operation, stopping the centrifugal pump (b-7), stopping the NAPL phase separation device (c), monitoring the liquid level in the tank body (b-2) through the gas-phase separation level gauge (b-5); when the liquid level is higher than an upper limit of a set gas-phase separation liquid level range, starting NAPL phase separation, operating the centrifugal pump (b-7), and operating the NAPL phase separation device (c) synchronously; when the gas-phase separation level gauge (b-5) detects that the liquid level in the tank body (b-2) is lower than a lower limit of the set gas-phase separation liquid level range or when the extraction operation needs to be stopped, stopping the centrifugal pump (b-7), stopping the NAPL phase separation device (c), and ending NAPL phase separation.

8. The automated multiphase extraction and separation system for contaminated sites according to claim 4, wherein
the control cabinet (f) acquires resistivity information of the electrode groups, controls the electrically controlled valves and the NAPL phase separation motor (c-3) to realize separation of the water containing dissolved organic matters, the light non-aqueous phase liquids (LNAPL) and the dense non-aqueous phase liquids (DNAPL), specifically comprising:
at the start of NAPL phase separation, starting the NAPL phase separation motor (c-3), closing the first NAPL phase separation electrically controlled valve (c-7-1), the second NAPL phase separation electrically controlled valve (c-7-2) and the third NAPL phase separation electrically controlled valve (c-7-3), monitoring resistivity through the first electrode group (c-11-1), the second electrode group (c-11-2) and the third electrode group (c-11-3);
when the first electrode group (c-11-1) detects that the resistivity reaches a set resistivity threshold for separating LNAPL, opening the second NAPL phase separation electrically controlled valve (c-7-2) to discharge the LNAPL;
when the third electrode group (c-11-3) detects that the resistivity reaches the set resistivity threshold for separating DNAPL, opening the third NAPL phase separation electrically controlled valve (c-7-3) to discharge the DNAPL;
when the second electrode group (c-11-2) detects that the resistivity reaches the set resistivity threshold for separating water, opening the first NAPL phase separation electrically controlled valve (c-7-1) to discharge the water containing dissolved organic matters;
if NAPL phase separation is to be ended, stopping the NAPL phase separation motor (c-3), closing the first NAPL phase separation electrically controlled valve (c-7-1), the second NAPL phase separation electrically controlled valve (c-7-2) and the third NAPL phase separation electrically controlled valve (c-7-3).

9. The automated multiphase extraction and separation system for contaminated sites according to claim 5, wherein
the control cabinet (f) controls the vacuum pumping device, specifically including: before the start of the extraction operation, setting an extraction negative pressure range in the control cabinet, the pressure being a negative value including a lower limit and an upper limit of the pressure range; adjusting the extraction negative pressure to be lower than the upper limit of the set pressure range through the vacuum pumping device (d), adjusting the extraction negative pressure to be higher than the lower limit of the set pressure range through the gas-phase separation electrically controlled valve (b-3);
at the start of the extraction operation, starting the vacuum pumping device (d), closing the gas-phase separation electrically controlled valve (b-3), monitoring the air pressure inside the tank body (b-2) through the air pressure sensor (b-4), when the air pressure inside the tank body (b-2) is lower than the upper limit of the set pressure range, stopping the vacuum pumping device (d); if the air pressure inside the tank body (b-2) is lower than the lower limit of the set pressure range, opening the gas-phase separation electrically controlled valve (b-3) to increase the air pressure until higher than the lower limit of the set pressure range, then judging whether to end extraction, if not, closing the gas-phase separation electrically controlled valve (b-3), returning to monitoring the air pressure inside the tank body (b-2) by the air pressure sensor (b-4), if ending extraction, ending the program.

10. The automated multiphase extraction and separation system for contaminated sites according to claim 1, wherein a touch screen is arranged on the control cabinet (f), and buttons for parameter setting, starting extraction and ending extraction are arranged on the touch screen for human-machine interaction.
